(19) United States
(12) Patent Application Publication
(10) Pub. No.: US 2023/0256604 A1
(43) Pub. Date: Aug. 17, 2023

(54) METHOD OF TRANSLATING BETWEEN ROBOTS AND DIFFERENT TOOLS OF ROBOTS IN RELATION TO COMMUNICATION BETWEEN THEM, CONVERSION DEVICE EMPLOYING METHOD, AND AUTONOMOUS MOBILE ROBOT

(71) Applicants: Futaijing Precision Electronics (Yantai) Co., Ltd., Yantai (CN); HON HAI PRECISION INDUSTRY CO., LTD., New Taipei (TW)

(72) Inventor: YU-SYUAN LYU, New Taipei (TW)

(21) Appl. No.: 17/730,393

(22) Filed: Apr. 27, 2022

(30) Foreign Application Priority Data
Feb. 11, 2022 (CN) 202210133744.5

(51) Int. Cl. B25J 9/16; B25J 15/04

(52) U.S. Cl. CPC B25J 9/1674; B25J 9/161; B25J 9/162; B25J 9/1679; B25J 15/04

(57) ABSTRACT

A device converting instructions and commands from an autonomous mobile robot into protocols compatible with different external tools comprises a robot body and a conversion device. The conversion device comprises a signal receiver, a signal converter, and a signal output device. The signal receiver receives a first operation signal outputted by the robot body, the signal converter converts the first operation signal to a second operation signal recognizable by the external tool, and the signal output device outputs the second operation signal to the external tool to achieve the desired operation by the external tool. The conversion device and a communication method of translating between robots and tools are also disclosed.

### TECHNICAL FIELD

The subject matter herein generally relates to command communications, in particular to converting command communications to or from robots.

### BACKGROUND

Autonomous mobile robots are widespread. When external tools and manipulators are fitted to an autonomous mobile robot, work efficiency or enlarged utility can be found. Communication protocols between robots and external tools made by different manufacturers may be different, external tools for robots from different manufacturers may require commands which are different from those for other external tools, resulting a large waste of resources.

### BRIEF DESCRIPTION OF THE DRAWINGS

Implementations of the present technology will now be described, by way of example only, with reference to the attached figures.

FIG. 1 is a diagram of an embodiment of a conversion device according to the present disclosure.

FIG. 2 is a diagram of an embodiment of a robot coupled to an external tool according to the present disclosure.

FIG. 3 is another diagram of an embodiment of a robot coupled to an external tool according to the present disclosure.

FIG. 4 is a flowchart of an embodiment of a method for converting communication and commands by robot into other communication protocols according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

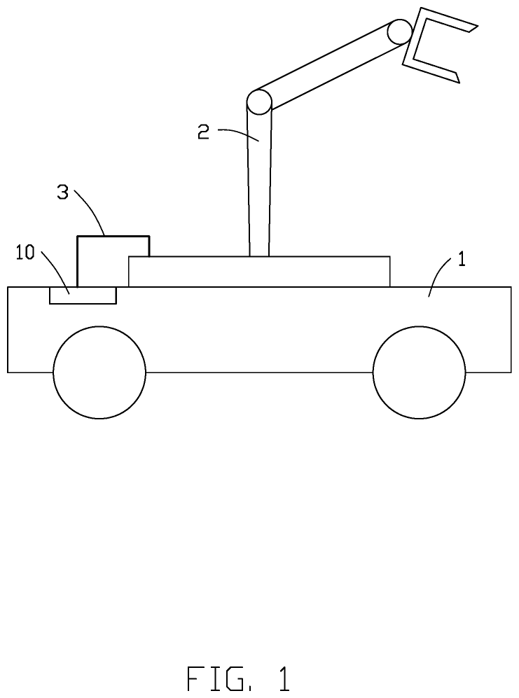

FIG. 1 illustrates a diagram of a robot 1 in one embodiment of the present application. The robot 1 can be an autonomous mobile robot (AMR), an automatic guided vehicle (AGV), etc. The robot 1 can communicate with an external tool 2 through a conversion device 10. For example, the robot 1 is the AMR and the external tool 2 is a mechanical arm, the AMR can control the mechanical arm through the conversion device 10. The conversion device 10 can comprise standard interfaces for compatibility with different robots and different external tools.

In one embodiment, the conversion device 10 and the external tool 2 can be installed on the robot 1, and the robot 1 can control the external tool 2 to perform an operation (for example, physically transferring a product from position A to position B through the external tool 2), expanding the functions and usage scenarios of the robot 1.

In one embodiment, the conversion device 10 can be integrated into the robot 1. Then, the robot 1 comprises a robot body and the conversion device 10.

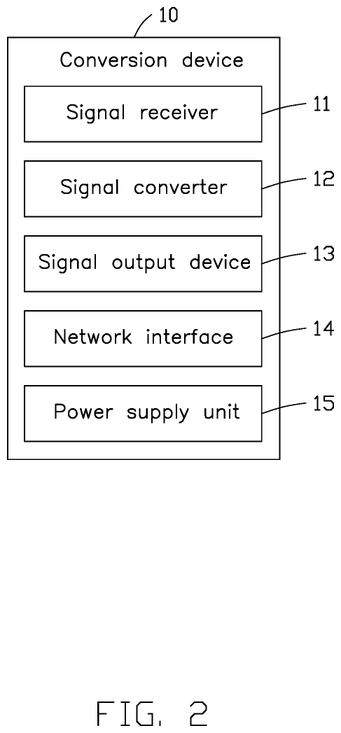

Referring to FIG. 2, the conversion device 10 comprises a signal receiver 11, a signal converter 12, and a signal output device 13. The signal receiver 11 is configured to receive a first operation signal outputted by the robot 1. The signal converter 12 is configured to convert the first operation signal to obtain a second operation signal recognizable by the external tool 2. For example, the signal converter 12 can convert the first operation signal based on a command format requirement of the external tool 2. The signal output device 13 is configured to output the second operation signal to the external tool 2. The external tool 2 can perform a desired operation based on the second operation signal. For example, the robot 1 can control the external tool 2 to take hold of a product through the conversion device 10.

In one embodiment, the conversion device 10 can further comprise a network interface 14, the conversion device 10 can couple to the external tool 2 through the network interface 14 and a network cable 3. For example, the external tool 2 also comprises a network interface, one end of the network cable 3 connects to the network interface 14, and the other end of the network cable 3 connects to the network interface of the external tool 2. The conversion device 10 can output the second operation signal to the external tool 2 through the network cable 3.

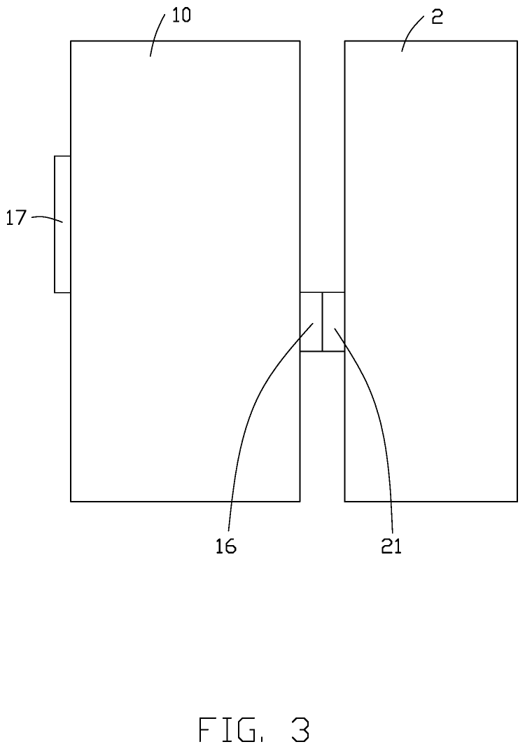

In one embodiment, referring to FIG. 3, the conversion device 10 can comprise a first connector 16, and the external tool 2 can comprise a second connector 21. The first connector 16 and the second connector 21 can be directly connected, omitting network cable 3. The conversion device 10 can output the second operation signal to the external tool 2 through the first connector 16 and the second connector 21.

In one embodiment, the conversion device 10 can further comprise a power supply unit 15, the power supply unit 15 can provide working voltage for the conversion device 10. The signal receiver 11, the signal converter 12, the signal output device 13, and the external interface 14 are coupled to the power supply unit 15 to obtain power. For example, the power supply unit 15 can connect to an external power supply, or the power supply unit 15 can comprise a battery.

In one embodiment, referring to FIG. 3, the conversion device 10 can comprise a power interface 17 to replace the power supply unit 15. When the conversion device 10 is installed on the robot 1, the power interface 17 is coupled to the robot 1 to supply power.

In one embodiment, the signal receiver 11 can comprise a stop signal receiving unit 110 and a reset signal receiving unit 112. The stop signal receiving unit 110 is configured to receive a first operation instruction outputted by the robot 1 to shut down the external tool 2. The reset signal receiving unit 112 is configured to receive a second operation instruction outputted by the robot 1 to reset the external tool 2.

In one embodiment, the signal receiver 11 can comprise other signal receiving units to meet requirements of the robot 1 for operating the external tool 2.

The conversion device 10 works as a signal converting medium between the robot 1 and the external tool 2, the conversion device 10 can receive various control signals sent by the robot 1, and convert received control signals into control commands that can be recognized by the external tool 2. The control commands are transmitted to the external tool 2 by the conversion device 10. The robot 1 can be connected to multiple types of external tool 2 through the conversion device 10, so as to achieve immediate utility, which is conducive to expanding the use field of the robot 1 and reducing need for multiple robots 1 and multiple external tools 2.

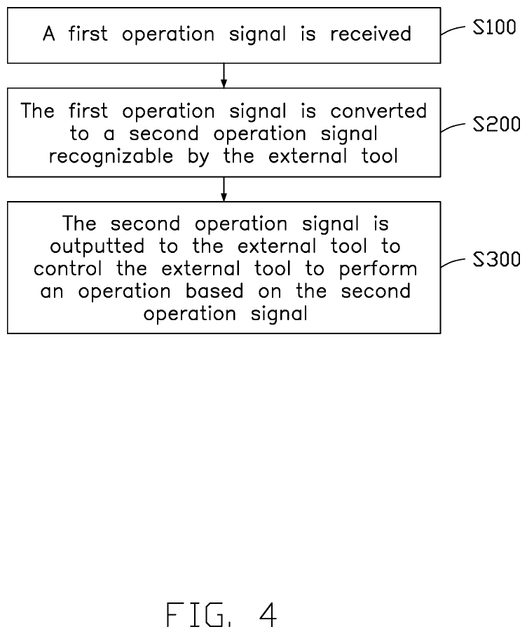

FIG. 4 illustrates one exemplary embodiment of a communication method of translating between robots and tools. The flowchart presents an exemplary embodiment of the method. The exemplary method is provided by way of example, as there are a variety of ways to carry out the method. Each block shown in FIG. 4 may represent one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can begin at block S100.

In block S100, a first operation signal is received.

In one embodiment, the first operation signal is outputted by the robot 1. For example, the first operation signal comprises a first operation instruction or a second operation instruction. The first operation instruction outputted by the robot 1 is configured to stop the activity of the external tool 2. The second operation instruction outputted by the robot 1 is configured to reset the external tool 2 in readiness for future use or different operation.

In block S200, the first operation signal is converted to a second operation signal recognizable by the external tool 2.

In one embodiment, the first operation signal can be parsed and converted by the conversion device 10 to obtain the second operation instruction that can be recognized by the external tool 2.

In block S300, the second operation signal is outputted to the external tool 2 to control the external tool 2 to perform an operation based on the second operation signal.

In one embodiment, the second operation signal can be outputted to the external tool 2 through a network cable.

In one embodiment, the conversion device 10 is coupled between the robot 1 and the external tool 2. In the configuration of the conversion device 10, basic control signals and power signals required to control the external tool 2 are preset, to allow recognition of instructions issued by the robot 1 and convert the instructions into control commands recognizable by the external tool 2. This allows interoperability and command compatibility between different robots and different external tools, expanding usage scenarios of the robot 1 and providing universal compatibility with external tools 2.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A conversion device communicating with a robot and an external tool, comprising:
a signal receiver configured to receive a first operation signal outputted by the robot;
a signal converter configured to convert the first operation signal to a second operation signal recognizable by the external tool; and
a signal output device configured to output the second operation signal to the external tool and control the external tool to perform an operation based on the second operation signal.

2. The conversion device of claim 1, further comprising a network interface, wherein the conversion device is coupled to the external tool through the network interface and a network cable.

3. The conversion device of claim 1, further comprising a power supply unit, wherein the signal receiver, the signal converter, the signal output device, and the external interface are coupled to the power supply unit to obtain power.

4. The conversion device of claim 1, further comprising a power interface, wherein when the conversion device is installed on the robot, the power interface is coupled to the robot to obtain power.

5. The conversion device of claim 1, wherein the signal receiver comprises a stop signal receiving unit, the stop signal receiving unit is configured to receive a first operation instruction outputted by the robot to shut down the external tool.

6. The conversion device of claim 1, wherein the signal receiver comprises a reset signal receiving unit, the reset signal receiving unit is configured to receive a second operation instruction outputted by the robot to reset the external tool.

7. The conversion device of claim 1, wherein the external tool is a mechanical arm.

8. The conversion device of claim 1, further comprising a first connector connectable to a second connector of the external tool.

9. An autonomous mobile robot (AMR) comprising:
a robot body; and
a conversion device installed on the robot body, wherein the conversion device is configured to couple to an external tool, the conversion device comprises:
a signal receiver configured to receive a first operation signal outputted by the robot body;
a signal converter configured to convert the first operation signal to a second operation signal recognizable by the external tool; and
a signal output device configured to output the second operation signal to the external tool, and control the external tool to perform an operation based on the second operation signal.

10. The AMR of claim 9, wherein the conversion device further comprises a network interface, the conversion device is coupled to the external tool through the network interface and a network cable.

11. The AMR of claim 9, wherein the conversion device further comprises a power interface, the power interface is coupled to the robot body to obtain power.

12. The AMR of claim 9, wherein the signal receiver comprises a stop signal receiving unit, the stop signal receiving unit is configured to receive a first operation instruction outputted by the robot to shut down the external tool.

13. The AMR of claim 9, wherein the signal receiver comprises a reset signal receiving unit, the reset signal receiving unit is configured to receive a second operation instruction outputted by the robot to reset the external tool.

14. The AMR of claim 9, wherein the external tool is a mechanical arm.

15. The AMR of claim 9, wherein the conversion device comprises a first connector connectable to a second connector of the external tool.

16. A communication method of translating between an autonomous mobile robot (AMR) and an external tool, the communication method comprising:
receiving a first operation signal outputted by the AMR;
converting the first operation signal to a second operation signal recognizable by the external tool;
outputting the second operation signal to the external tool, and controlling the external tool performing an operation based on the second operation signal.

17. The communication method of claim 16, wherein the AMR communicates with the external tool through a network cable.

18. The communication method of claim 16, wherein receiving the first operation signal outputted by the AMR comprises:
receiving a first operation instruction outputted by the AMR to shut down the external tool.

19. The communication method of claim 16, wherein receiving the first operation signal outputted by the AMR comprises:
receiving a second operation instruction outputted by the AMR to reset the external tool.
